(19) United States
(12) Patent Application Publication
(10) Pub. No.: US 2026/0229952 A1
(43) Pub. Date: Aug. 6, 2026

(54) COMPONENT WITH AN INTEGRATED CONDUCTOR TRACK CONNECTOR AND ASSEMBLY

(71) Applicant: Thomas Magnete GmbH, Herdorf (DE)

(72) Inventor: Bernd BECHHEIM, Lüdenscheid (DE)

(21) Appl. No.: 19/154,920

(22) PCT Filed: Jan. 4, 2024
(86) PCT No.: PCT/EP2024/050128

§ 371 Date: Aug. 8, 2025

(30) Foreign Application Priority Data
Feb. 14, 2023 (DE) 10 2023 103 505.3

(51) Int. Cl. H02K 5/22; H02K 3/50

(52) U.S. Cl. CPC H02K 5/225; H02K 3/50; H02K 2203/09; H02K 2211/03

(57) ABSTRACT

A component with an integrated conductor track connector, having a plurality of electrical conductors, in particular as a stamped grid; a first overmoulding which at least partially encases the electrical conductors and defines an arrangement of the electrical conductors for forming the conductor track connector and at least a second overmoulding which at least partially encases the first overmoulding and forms a component section of the component, wherein at least the first overmoulding has at least one resilient and/or fixing structure which is designed to cushion the component with respect to an adjacent second component and/or fix the component on said second component. A component relates to an assembly having the component with an integrated conductor track connector.

### CROSS-REFERENCE TO RELATED APPLICATIONS

This application is a National Stage of International Application No. PCT/EP 2024/050128, filed Jan. 4, 2024, which claims the benefit of and priority to German Patent Application DE 102023103505.3, filed Feb. 14, 2023. The entire disclosures of the above applications are incorporated by reference herein.

### FIELD

The invention relates to a component with an integrated conductor track connector and to an assembly having the component with the integrated conductor track connector.

### BACKGROUND

This section provides background information related to the present disclosure which is not necessarily prior art.

Conventional lead frame connectors comprise a plurality of electrical conductors which are stamped from a metal plate and are encapsulated by a solid plastic, the lead frame connector. This plastic ensures relative positioning of the electrical conductors relative to one another and forms the lead frame connector. The latter is joined in a subsequent process to form a superordinate component. This superordinate component is then joined to form a complete assembly. In order to compensate tolerances of individual parts and joining tolerances of a superordinate assembly of the interconnected components, a separate component such as, for example, a rubber-like component is conventionally arranged between the lead frame connector and the adjoining component. Additional costs are incurred as a result. The weight of the assembly likewise increases as a result. Furthermore, a fitting process for such an assembly is consequently very complex. Such lead frame connectors do not assume any other functions in the superordinate assembly.

### SUMMARY

This section provides a general summary of the disclosure, and is not a comprehensive disclosure of its full scope or all of its features.

An object is to provide a component with an integrated conductor track connector which is inexpensive and enables time-and cost-efficient fitting thereof in an assembly. An object is moreover to provide an assembly with these advantages.

The objects can be achieved in particular by a component with an integrated conductor track connector. The component has a plurality of electrical conductors, a first encapsulation, and at least one second encapsulation. The first encapsulation encases the electrical conductors at least partially and defines an arrangement of the electrical conductors for forming the conductor track connector. The second encapsulation encases the first encapsulation at least partially and forms a component section of the component. At least the first encapsulation has at least one resilient and/or fixing structure which cushions the component with respect to an adjoining second component and/or fixes it thereon.

An integral cushioning and/or fixing function of the conductor track connector integrated into the component is consequently enabled by the first encapsulation, as a result of which there is in particular no need to provide additional resilient and/or fixing structures. The integral cushioning and/or fixing structure is, in a fitted state of the component, in contact with the adjoining second component.

Together with the electrical conductors, the first encapsulation advantageously forms the conductor track connector. The second encapsulation advantageously forms the (remaining) component, wherein the second encapsulation at least partially encases the first encapsulation and the electrical conductors such that the conductor track connector is integrated into the component. The at least one second encapsulation here forms the component interface of the component, wherein the component comprises the component sections and the conductor track connector.

The component can advantageously have a plurality of first encapsulations. Such a plurality of encapsulations are formed in a multi-component injection-molding process or formed in multiple individual injection-molding processes one after the other.

The component particularly has precisely one second encapsulation. The component particularly has precisely one first encapsulation.

It is particularly advantageous if the plurality of electrical conductors are designed as a lead frame. Alternatively or additionally, at least one electrical conductor can be formed by etching a metal layer and, together with the first encapsulation, form a printed circuit board. In other words, in an alternative embodiment, the conductor track connector is a printed circuit board integrated into the component.

The first encapsulation and the at least one second encapsulation advantageously have different material properties. The first encapsulation and the at least one second encapsulation here differ in their elasticities. The first encapsulation is particularly easier to deform elastically than the second encapsulation and thus has in particular a lower modulus of elasticity than the second encapsulation. For example, the first encapsulation is formed from an elastic plastic. The at least one second encapsulation is formed from a solid and/or hard plastic.

The resilient structure of the first encapsulation is a projection, wherein the projection has in particular a higher elasticity than the second encapsulation. The projection protrudes from a surface of the first encapsulation, in particular in the direction of the adjoining component. The projection is advantageously in contact with the adjoining component in a fitted state. The projection particularly extends in a projection direction of extent perpendicular to a direction of extent or longitudinal direction of the electrical conductors.

In an advantageous embodiment, the at least one resilient structure of the first encapsulation is designed with a spiral shape or in the form of a leaf spring or with a corrugated shape. A plurality of resilient structures can be present which have different forms.

The at least one fixing structure is a clamp and/or a hook which is configured to engage in the adjoining second component and to fix the component thereon. The design of at least one structure as a clamp or as a fixing hook is combined with the design of the same structure as resilient (a fixing and resilient structure). For example, such a resilient and fixing structure is designed as a spring-loaded clamp or as a hook in the form of a leaf spring.

The at least one fixing structure is a threaded tube which is configured to receive a screw for fixing the component on the adjoining second component. The structure formed as a threaded tube is a fixing and resilient one. The fixing and resilient threaded tube here advantageously has a higher elasticity than the second encapsulation.

In an advantageous embodiment, the first encapsulation is formed from an elastic material. The first encapsulation is advantageously formed from an elastic plastic, in particular from a thermoplastic and/or elastomer. The elasticity of the first encapsulation is advantageously higher than that of the second encapsulation at the same temperature. The elasticity here refers to an intrinsic material property of the first encapsulation and the second encapsulation which is independent of a geometrical design of the corresponding encapsulation.

The second encapsulation is advantageously formed from a solid plastic.

The first encapsulation and the at least one resilient and/or fixing structure are jointly formed as an injection-molded component.

The first encapsulation and at least one second encapsulation are jointly formed as a multi-component injection-molded component. It is particularly preferred if the first encapsulation and all the second encapsulations, in particular a single second encapsulation, are jointly formed as an injection-molded component, in particular a multi-component injection-molded component. The first encapsulation and the at least one second encapsulation are jointly formed as a two-component injection-molded component, wherein the first encapsulation comprises a first component and the second encapsulation comprises the second component.

Advantageously, in order to produce the component with an integrated conductor track connector, first the electrical conductors are inserted, as a lead frame, into a first die, in particular a first injection-molding die, and encapsulated with the first encapsulation. This results in the conductor track connector as a semi-finished product (of the component). The conductor track connector formed in this way has (integrally) the at least one resilient and/or fixing structure. The conductor track connector is then inserted into a second die which is different from the first die and encapsulated with the second encapsulation. This results in the component with the integrated conductor track connector. The second encapsulation or the second die essentially define the geometry of the component.

In an advantageous embodiment, the injection-molding material of the first encapsulation has a higher elasticity than that of the second encapsulation. As a result, when the second encapsulation is formed, an essentially gas-tight connection is produced between the first encapsulation (the conductor track connector) and the second encapsulation, as a result of which corrosion of the electrical conductors can be avoided or reduced.

The assembly comprises the component with an integrated conductor track connector according to one of the above embodiments. The component with an integrated conductor track connector is a stator cover (with an integrated conductor track connector). The assembly moreover has a second component adjoining the component with the integrated conductor track connector. The adjoining second component is in particular a stator of an electric machine. The assembly moreover has a third component which is connected to the component with an integrated conductor track connector. The third component is in particular a stator holding means or holder. The second component is clamped between the first encapsulation of the component with an integrated conductor track connector and the third component.

The first encapsulation of the component with the integrated conductor track connector is here configured: to at least partially compensate tolerances of individual parts and/or assembly tolerances between the components by at least one resilient structure and/or to fix the first component on the second component by at least one fixing structure. In the advantageous embodiments of the structure as resilient and fixing structures, the first encapsulation is configured to at least partially compensate tolerances of individual parts and/or assembly tolerances between the components and at the same time to fix the first component on the second component.

The second component is particularly a housing of the stator of the electric machine. The conductor track connector is here configured to be connected to the stator of the electric machine so as to conduct electrical current and/or signals. The stator cover covers the stator in a fitted state.

It is particularly preferred if the stator cover (the second encapsulation) is formed by encapsulating the conductor track connector (first encapsulation) and the integral connection, formed in this way as a common component, consisting of the conductor track connector and the stator cover is assembled with the stator/stator housing (second component) in order to cover the stator/stator housing and enable an electrical connection.

The component with the integrated conductor track connector is connected to the third component. These components are welded and/or screwed and/or glued and/or clipped to one another.

Further areas of applicability will become apparent from the description provided herein. The description and specific examples in this summary are intended for purposes of illustration only and are not intended to limit the scope of the present disclosure.

### DRAWINGS

Further details, advantages, and features of the present invention can be found in the following description of exemplary embodiments on the basis of the drawings, in which:

FIG. 1 shows a schematic detailed view of a conductor track connector of a component according to a first embodiment;
FIG. 2 shows a schematic view in section of an assembly having the component according to the first embodiment;

FIG. 3 shows a schematic detailed view of a conductor track connector of a component according to a second embodiment; and

FIG. 4 shows a schematic view in section of an assembly having the component according to the second embodiment.

Corresponding reference numerals indicate corresponding parts throughout the several views of the drawings.

### DETAILED DESCRIPTION

Example embodiments will now be described more fully with reference to the accompanying drawings.

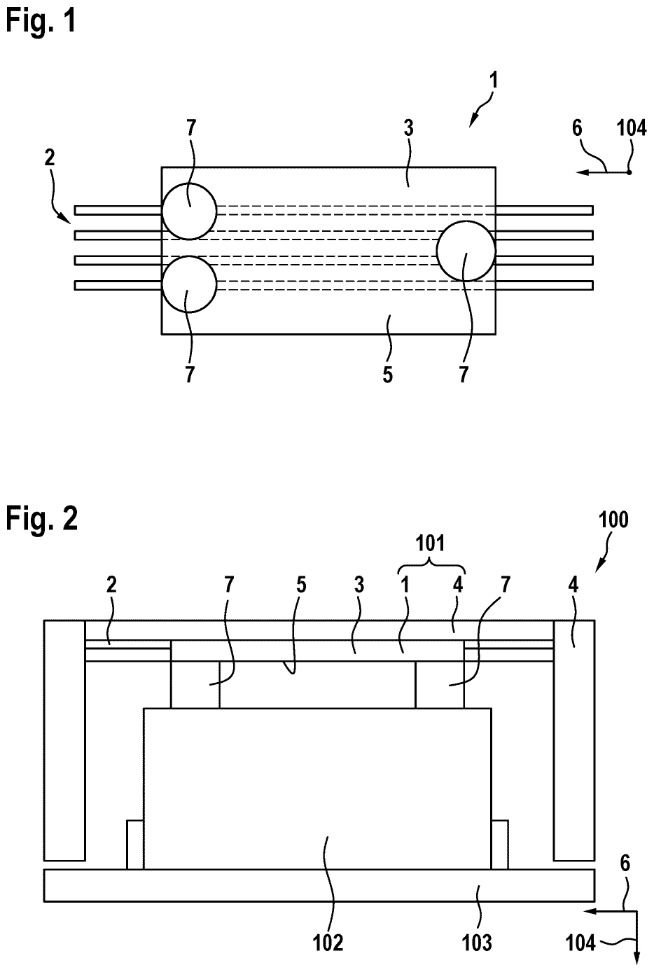

FIG. 1 shows a schematic detailed view of a conductor track connector 1 of a component 101 according to a first embodiment. The first component 101 is illustrated in FIG. 2 which shows a schematic side view of an assembly 100 having the first component 101 according to the first embodiment.

The conductor track connector 1 has a plurality of electrical conductors 2. The electrical conductors 2 are here designed as a lead frame. The conductor track connector 1 moreover has a first encapsulation 3 which partially encases the electrical conductors 2. In the present example, as illustrated in FIG. 1, the electrical conductors 2 protrude from the first encapsulation 3. An electrical connection of the electrical conductors 2 to further components and/or terminals (not illustrated) is thus enabled. The first encapsulation 3 is formed in particular by encapsulation, in particular by injection molding, of the electrical conductors 2, in particular as a lead frame.

The first encapsulation 3 and the electrical conductors 2 are referred to below also jointly as a conductor track connector 1.

The first encapsulation 3 has a plurality of, in this example three, resilient structures 7. In the present example, the resilient structures 7 are formed as cylindrical projections which extend in a projection direction of extent 104 (also referred to below as “fitting direction”). The projection direction of extent 104 is perpendicular to a direction of extent 6 of the electrical conductors 2. The direction of extent 6 of the electrical conductors 2 here relates to a main longitudinal extent of the electrical conductors 2.

The resilient structures 7 are formed as a single part, in particular by injection molding, with the first encapsulation 3. The first encapsulation 3 is formed from an elastic material, in particular from an elastic plastic, such that the projections 7 have a resilient function/effect.

The conductor track connector 1 is integrated into the first component 101, as will be explained below with reference to the assembly 100 in FIG. 2.

The first component 101 has a second encapsulation 4 which partially encases the first encapsulation 3 together with the electrical conductors 2. In the present example, the projections 7 protrude from the second encapsulation 4. As mentioned above, the first encapsulation 3 is formed from an elastic plastic. The second encapsulation 4 is formed from a solid plastic which has a lower elasticity than the material of the first encapsulation 3. Strength and/or stiffness of the component 101 can be ensured as a result. Furthermore, when the first encapsulation 3 is encapsulated with the second encapsulation 4, an essentially gas-tight connection is created between them such that, for example, corrosion of the electrical conductors 2 can be prevented or reduced. The first component 101 thus has the integrated conductor track connector 1 and component sections, wherein the component sections are sections of the component 101 in addition to the conductor track connector 1.

The assembly 100 has the (first) component 101 explained above, a second component 102, and a further third component 103. The first component 101 is, for example, a stator cover. The second component 102 is, for example, a stator or a stator housing and is also referred to as an adjoining second component 102. The third component 103 is, for example, a holding, holder or fixing means of the stator.

The first component 101, the second component 102, and the third component 103 are assembled in the fitting direction 104 (the “projection direction of extent” above). The first component 101 and the third component 103 are connected to each other, such as welded to each other. As a result, the second component 102 is clamped between the first component 101 and the third component 103. The conductor track connector 1 is here situated, as an integral constituent part of the first component 101, between the second encapsulation 4 of the first component 101 and the second component 102.

The resilient structures 7, here the projections 7, of the first encapsulation 3 are configured to cushion the first component 101 with respect to an adjoining component, in this example with respect to the second component 102. As a result, tolerances of individual parts and/or assemblies, for example manufacturing tolerances and/or temperature-dependent tolerances, are compensated by the projections 7.

In the present embodiments, the resilient structures 7 are formed in each case as in particular cylindrical projections which project from a lower surface 5 of the first encapsulation 3. The projections 7 here extend in particular in the fitting direction 104.

The projections 7 ensure in particular that further resilient components such as, for example, rubber rings are not absolutely necessary because the cushioning function is already integrated into the first component 101.

Although not illustrated, at least the first component 101 has openings of which the electrical conductors 2 can be contacted and/or routed to the outside.

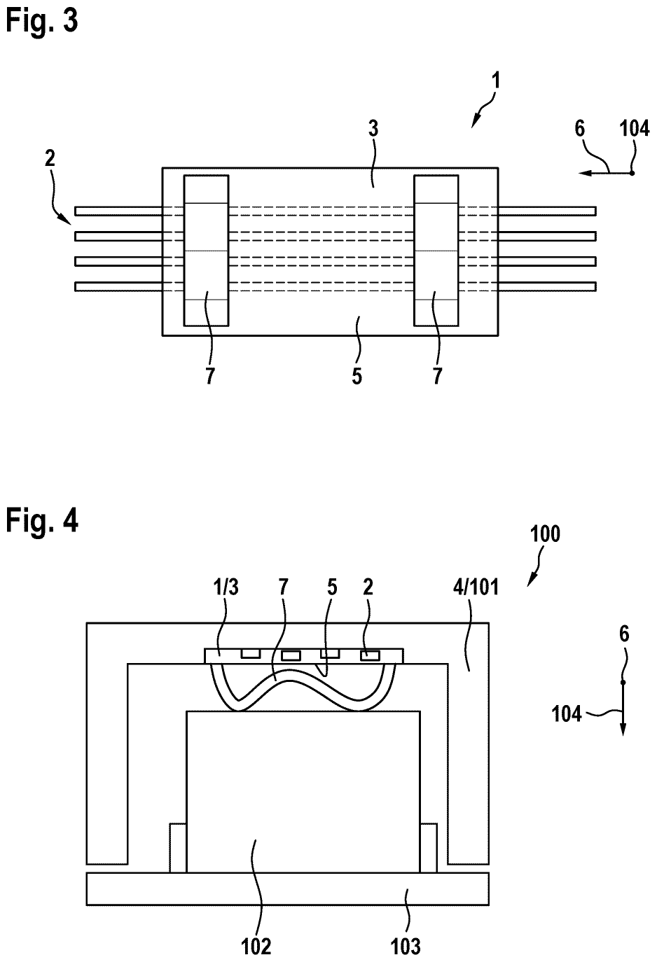

FIG. 3 shows a schematic detailed view of a conductor track connector 1 of a component 101 according to a second embodiment. FIG. 4 shows a schematic side view of an assembly 100 having the first component 101 according to the second embodiment.

In the first embodiment explained above, the resilient structures 7 have a resilient function owing to their material properties, in particular their elasticity. In the second embodiment explained below, the resilient function of the structures 7 is advantageously achieved at least partially by a form of the structures 7.

As shown by a comparison between FIG. 3 and FIG. 4, the conductor track connector 1 has two corrugated resilient structures 7. The first encapsulation 3, together with the resilient structures 7, here comprise elastic material. Alternatively, the first encapsulation 3, together with the resilient structures 7, can jointly be formed from a solid plastic. For example, the first encapsulation 3 and the second encapsulation 4 can here be formed from the same material.

The corrugated shape, illustrated in FIG. 4, of the structures 7 ensures elasticity, caused by their shape, of the structures 7 such that the latter cushion the first component 101 with respect to the second component 102.

The elastic form of the structures 7 is not restricted to the corrugated shape illustrated. The structures 7 can, as an alternative or in addition to the corrugated shape illustrated, be designed with a spiral shape or in the form of a leaf spring.

The structures 7 can, as an alternative or in addition to the resilient function illustrated, fulfill a fixing function. For example, at least one structure 7 is here designed as a hook which engages in the second component 102. For this purpose, the second component 102 has, for example, an eye and/or a cutout and/or an undercut. The fixing function is combined with the resilient function. For example, such a structure 7 designed as a hook is formed from an elastic material.

Moreover, for example by virtue of the provision of an internal thread in at least one of the structures 7 illustrated in FIGS. 1 and 2, the structures 7 can be designed as threaded tubes which are configured to receive a screw for fixing the first component 101 and the second component 102. Owing to an elastic design of such a structure 7 as a threaded tube, a simultaneously resilient and fixing integral structure of the component 101 can be provided.

In addition to the above written description of the invention, reference is hereby made explicitly to the illustration of the invention in drawings in FIGS. 1 to 4 for supplementary disclosure thereof.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

### LIST OF REFERENCE SIGNS

1 conductor track connector
2 electrical conductor
3 first encapsulation
4 second encapsulation
5 lower surface
6 direction of extent of the electrical conductors
7 structure
100 assembly
101 first component
102 second component
103 third component
104 fitting direction (projection direction of extent)

1-9. (canceled)

10. An assembly comprising:
a first component with an integrated conductor track connector as a stator cover, the first component having:
a plurality of electrical conductors, as a lead frame;
a first encapsulation which encases the plurality of electrical conductors at least partially and defines an arrangement of the electrical conductors for forming the integrated conductor track connector; and
at least one second encapsulation which encases the first encapsulation at least partially and forms a component section of the first component, wherein at least the first encapsulation has at least one resilient and/or fixing structure;
the adjoining second component, as a stator of an electric machine, which is connected to the first component with an integrated conductor track connector; and
a third component, as a stator holder, which is connected to the first component with an integrated conductor track connector, wherein
the second component is clamped between the first encapsulation of the first component with an integrated conductor track connector and the third component; and wherein
the resilient and/or fixing structure is configured to cushion the first component with respect to the adjoining second component and/or to fix it thereon.

11. The assembly as claimed in claim 10, wherein the first encapsulation and the at least one second encapsulation have different material properties, in particular different elasticities.

12. The assembly as claimed in claim 10, wherein the resilient structure of the first encapsulation is a projection, wherein the projection has in particular a higher elasticity than the second encapsulation.

13. The assembly as claimed in claim 10, wherein the at least one resilient structure is designed with a spiral shape or in the form of a leaf spring or with a corrugated shape.

14. The assembly as claimed in claim 10, wherein the fixing structure is a clamp and/or a hook which is configured to engage in the adjoining second component and to fix the first component thereon.

15. The assembly as claimed in claim 10, wherein the fixing structure is a threaded tube which is configured to receive a screw for fixing the first component on the adjoining second component and, in particular as a fixing and resilient structure, has a higher elasticity than the second encapsulation.

16. The assembly as claimed in claim 10, wherein the first encapsulation is formed from an elastic material, in particular from an elastic plastic.

17. The assembly as claimed in claim 10, wherein the first encapsulation and the at least one resilient and/or fixing structure are jointly formed as an injection-molded component.
